(19) United States
(12) Patent Application Publication
(10) Pub. No.: US 2006/0237284 A1
(43) Pub. Date: Oct. 26, 2006

(54) Handrail, handrail guiding system, and handrail drive system of an escalator or moving sidewalk

(76) Inventor: Herwig Miessbacher, Grosslobming (AT)

Correspondence Address: GREENBLUM & BERNSTEIN, P.L.C., 1950 ROLAND CLARKE PLACE, RESTON, VA, 20191, US

(21) Appl. No.: 10/559,537

(22) PCT Filed: Jun. 4, 2004
(86) PCT No.: PCT/AT04/00196

§ 371 Date: Feb. 24, 2006

(30) Foreign Application Priority Data
Jun. 4, 2003 (AT) A860/2003

(51) Int. Cl. B66B 23/22

(52) U.S. Cl. 198/336

(57) ABSTRACT

The invention describes a handrail driving system (2), a handrail guiding system (8) and a handrail (1), for example for an escalator (4) or a people-mover or moving sidewalk. The handrail driving system (2) comprises at least one driving element (10), which is actively connected with a driving motor (12) and formed for contacting the handrail (1) in defined areas, whereby at least in the contact area (13) intended for contacting the handrail (1), the driving element (10) is realized by a material forming in cooperation with a material of the handrail an interacting material pairing having a static coefficient of friction of higher than or equal to 0.95.

The invention relates to a handrail driving system, a handrail guiding system, a handrail, as well as to an overall system comprised of said components, as described in the introductory parts of claims 1, 16, 21 and 51.

Handrails mainly serve the purpose of increasing the transport safety for individuals, particularly people to be transported by means of escalators and horizontally moving people-movers, or moving sidewalks, and similar devices, whereby the handrails used in such fields of application are designed in the form of gripping pieces provided at least by sections. In the present connection, the handrails are usually designed as a type of endless strand that is driven at a constant rate and supported by reversing rollers, whereby the handrail is guided on the top side of a balustrade in a way such that it is accessible to such individuals, and preferably inaccessibly driven on the bottom side of the balustrade in an endless loop preferably in the substructure accommodating the driving system.

The handrails usually have an about C-shaped cross-sectional profile, whereby due to the length-to-thickness ratio of C-shaped cross-sectional profiles which, viewed in the cross section, is unfavorable with respect to the tensile strength, such profiles are formed by a number of layers consisting of different materials, e.g. special layers for increasing the tensile strength. Therefore, the handrails known in the prior art are afflicted with the drawback of cost-intensive manufacture, because for obtaining the required component characteristics such as, e.g. high tensile strength, resistance to scratching, dimensional stability etc., the handrails can be manufactured by means of the usually employed vulcanization or extrusion methods only in a manufacturing process requiring substantial expenditure in that the manufacture of handrails produced in the form of multi-layered composite parts requires a costly manufacture of the semi-finished product with substantial production expenditure.

A handrail drive with a handrail driven by said drive is shown, e.g. in DE 198 50 037 A1. The handrail drive of an escalator, where the handrail is brought into contact with a handrail driving disk under pressure, is connected with a driving sprocket wheel by means of a driving chain. The handrail is driven by applying pressure to the handrail and the use of a handrail driving disk, whereby such a driving disk comprises a hose for supplying variable air pressure, which is installed on the peripheral surface of the handrail driving disk, causing the handrail to be in contact with the handrail driving disk under pressure. The design of the handrail is, in the present connection, of the type of a C-shaped profile.

Another driving arrangement for a movable handrail is shown in EP 0 528 387 B1, whereby the handrail interacts with an endless driving belt and the latter is guided around a pair of reversing rollers that are spaced from one another. In addition, a counteracting endless belt is arranged on an opposite surface and guided around end rollers spaced from each other. In this connection, the handrail as such again has a profile with a C-shaped cross-section.

The problem of the present invention is to design a handrail driving system, a handrail guiding system and a handrail in such a way that said systems and said handrail can be manufactured in a simpler way at more favorable cost. Furthermore, a part problem of the invention is to permit a compact structure and a long service life of said components.

Said problem and said part problem each are independently resolved by the features specified in the characterizing clauses of claims 1 and 21, respectively. The ensuing advantage mainly lies in that the materials paired with one another and adjoining one another between the driving element and the handrail, with a static coefficient of friction of greater than or equal to 0.95 being built up in the area where the materials are adjoined, enter into a reliable friction grip with less pressure required per area unit, so that in the presence of relative motion between the driving element and the handrail, the latter being in contact with the former can be reliably driven. Any sliding friction that might occur in the area where the paired materials are in contact with each other, thus can be substantially excluded, which results in a friction drive with very high operational safety. Furthermore, it is advantageous in conjunction with the handrail according to claim 21 that it is possible in this way to provide the user of the handrail with higher safety against possible injuries caused by getting caught in the area where the handrail is guided.

A further development according to claim 2 is advantageous in that owing to the driving wheel, the rotational motion of the driving motor can be directly converted into a linear movement of the handrail through interaction with the latter.

With the embodiment variation defined according to the features specified in claim 3, any risk of occurrence of sliding friction in the area where the components are in contact with each other is reduced owing to the special material properties of rubber.

The embodiment variation according to claim 4 results in the advantage that the friction grip between the driving element and the handrail is produced or increased in the contact area due to expansion of the frictional body, because the contact pressure interacting between the contact surfaces is variable due to the change in volume of the friction body. The use of a hollow body such an air-inflatable rubber tire is particularly advantageous in this connection in that the elastomeric rubber material has favorable properties of static friction, and, in addition, in that the contact pressure interacting between the two surfaces in contacting one another in the contact area can be increased by changing the air pressure in the rubber tire.

The variation according to claim 5 is advantageous in that the adhesion of the contact surfaces to one another can be increased in the contact area by fiber-like structures such as, e.g. microfibers having increased adhesive properties when applied to surfaces.

The embodiment according to claim 6 offers the benefit that the material of the driving element can be provided by a separate component, which means that outsourced or mass-produced components can be used at favorable cost. This is feasible in conjunction with driving wheels in a particularly simple manner by using bearing cups or bearing sleeves with high surface friction.

The embodiment variation according to at least one of claims 7, 8 and 23 is advantageous in that the reliability of the frictional or nonpositive transmission of motion can be raised by a wide area of contact, and adequate static friction can be built up by having the driving element is in plane contact with the handrail over the entire contact area.

The embodiment variation according to claims 9 and 22 offers the benefit that the driving element, in conjunction with a handrail, can be formed and accommodated in a highly space-saving manner in the substructure or balustrade, e.g. of an escalator.

Owing to the embodiment according to claim 10, it is advantageous that the compressive force acts laterally on the handrail due to driving elements, particularly driving wheels arranged laterally of the handrail, i.e. any lift-off of the handrail upwards, which is not desirable, is made more difficult or prevented.

The embodiment variation according to at least one of claims 11 and 12 is advantageous in that the transmission of force to the handrail can be additionally secured by a plurality of driving elements, and in that failure of individual driving elements can be compensated by making provision for a plurality of driving elements for upgrading the operational safety.

The embodiment variation according to claim 13 results in the advantage that owing to a positive connection between the handrail and the driving element, the transmission of force to the handrail is enhanced, and any unintentional detachment of the handrail from the driving element is made more difficult at the same time, whereby the design variations according to at least one of claims 14 and 15 describe particularly advantageous positive means for connecting a driving wheel with the handrail by friction grip.

The problem of the invention is independently resolved by the features specified in the characterizing clause of claim 16 as well. The advantage resulting from such features mainly lies in smoother relative displaceability of the handrail and the handrail guiding system in relation to one another, which permits material wear of the guiding element resting against the handrail to be kept low. Furthermore, due to reduced frictional resistance, lower driving or conveying force acting on the handrail is required for driving the latter, which means handrail driving systems with smaller dimensions and longer maintenance intervals can be used at more favorable cost. The friction coefficients specified in claim 25 were found to be particularly advantageous.

The design variation according to at least one of claims 17 and 18 is advantageous in that the material and structures specified above have particularly favorable sliding properties in the contact area.

The design variation according to at least one of claims 19 and 20 are advantageous in that in this connection, the handrail is displaceable along its longitudinal expanse on the sliding surface relative to the guiding element, and in that due to the positive interaction between the guiding element and the handrail, for example in a recess, it is possible to arrange the handrail there in a substantially fixed position , where it is arranged secured on the handrail guiding system against lift-off in the direction extending crosswise to its longitudinal direction, with the handrail being displaceable only in its longitudinal direction.

Furthermore, the design variation according to claim 24 is advantageous in that with a handrail, with a handrail surface divided in several contact areas, particularly by sections, with different friction properties in the various contact areas, the various interactions entered into by the handrail with the driving element, permit realizing in a simple manner an active connection between said components by friction grip, on the one hand, and a sliding connection between it and the guiding system, on the other hand. Thus the different functions of the handrail with respect to adhesive and sliding effects are uncoupled from each other, which means that the respective functions can be optimized and changed independently of one another, so that a very high driving output can be transmitted by the handrail driving system to the handrail. Thus a compact structure of a system comprising the handrail as defined by the invention, and not requiring any intensive maintenance expenditure can be realized.

The design variation according to claim 26 is beneficial as well in that a handrail surface formed by a uniform material can be provided in different sections with different grades of surface roughness due to different surface treatments applied in the various sections, and thus can be brought into the condition required for friction grip and sliding suitability, which permits the production of the handrail to be simplified.

With the variation according to claim 27, it is advantageous that guiding elements can be positively engaged with the handrail, thus permitting reliable and safe guidance of the handrail in the recess that is secured against detachment of the handrail, whereby such an effect can be obtained by the simple structural measures specified in claim 28.

The embodiment according to claim 29 is advantageous in that the areas intended for different stress conditions acting on the handrail, or for different functions of the latter, are uncoupled from one another by the specified structure, whereby such areas be adapted to their specific requirements, and whereby the handrail may have a substantially known, e.g. a double T-shaped cross-sectional profile.

It is beneficial in connection with the embodiment according to claim 30 that the handrail can be used by people in a simple and safe way owing to the special gripping surface on the upper belt.

The design variation according to claim 31 is advantageous in that guiding elements and elements of the handrail driving system hidden by means of the handrail reduce the risk of injury to people gripping the handrail, and that damage to the handrail or to the driving and guiding systems due to penetration of external objects into the handrail or said systems can be prevented.

The design variation according to claim 32 is advantageous as well in that stresses occurring within the confinements of the guiding and driving systems are limited to the area of the lower belt, whereby the latter can be substantially actively uncoupled from the upper belt, and the properties of the latter can be optimized.

Owing to the embodiment according to claim 33, the manufacture of the handrail can be simplified by reduced tool preparation or tooling, and cycle times in the manufacturing process can be reduced as well.

Embodiments according to at least one of claims 34 to 36 are advantageous in that due to the specified dimensions, a dimensionally stable handrail with good strength properties is formed, which, however, is secured at the same time against unintentional detachment from the handrail guiding system by adequate engagement with the latter, and guided with low wear as well.

The design variation according to claim 37 substantially results in the advantage of obtaining additionally increasable tensile strength properties of the handrail.

The embodiment variations according to at least one of claims 38, 39 and 40 are advantageous in that the specified profile cross-sections and their surface area dimensions permit forming a one-piece and flexible handrail with tensile strength properties adequate for using such a handrail in conjunctions with escalators or people-movers, whereby the handrail is not required to comprise any additional layers increasing the tensile strength, so that the handrail production can be accelerated through simplified tool preparation, and its costs can be reduced.

Furthermore the embodiment of the handrail according to claim 41 is possible, by which the functions “sliding” and “driving” can be separated in a simple and safe manner.

The embodiment according to claim 42 is advantageous in that by means of pairing materials of which at least one is formed by an elastomeric material, particularly rubber, the transmission of motion in a nonpositive manner or by friction grip is possible with less pressure applied per unit area than by means of non-elastomeric material pairings, so that the wear of the components can be minimized and the maintenance intervals prolonged in this way.

The embodiment according to the features of claim 43 results in the advantage that the contact surface in the contact area is limited by the profiling to the area of its elevations, and the overall contact surface area between the handrail and the guiding element can be reduced for lowering the sliding resistance. On the other hand, however, it is possible also to increase the adhesion between the driving element and the handrail by a combined friction and positive grip in an advantageous manner.

Owing to the embodiment according to claim 44, the different friction coefficients in the different contact areas can be obtained by selecting specifically suitable different materials or sliding layers, and it is possible to substantially maintain such friction coefficients permanently and free of maintenance. The materials or sliding layers proposed in claims 45 and 46 were found to be particularly advantageous.

Owing to the embodiment according to claim 47, it is advantageously possible to provide the handrail driving system and/or handrail guiding system and/or the handrail with enhanced or special component properties at some later time, whereby prefabricated, separate sliding and friction layers can be used that can be produced independently of the other components.

By virtue of the features according to claim 48 it is possible in an advantageous manner to form the basic body of the driving element and/or guiding element and/or handrail from a different material in the contact area. In this way, materials can be used for the driving element, e.g. for transmitting the torque of the driving element in the area where the driving shaft is connected, that are available at favorable cost and suitable for the requirements within the specific area of the basic body.

What is achieved by design variations according to at least one of claims 49 and 50 is that the handrail driving and/or the handrail guiding elements and the handrail can be provided at a later time with special component properties, particularly with increased tensile strength, which is achieved by means of reinforcing layers incorporated in a coating. In particular, the handrail can be produced in a simple manner from a uniform material by means of known vulcanization or extrusion methods, because the additional coating is applied only in a subsequent production step.

The problem of the invention is independently resolved also by claim 51, whereby the handrail and/or the handrail driving system and/or the handrail guiding system can be formed as specified in the claims specified above, so that an overall system offering the advantages described above can be realized.

The invention is described in greater detail in the following with the help of the exemplified embodiments shown schematically and simplified in the drawings, in which:

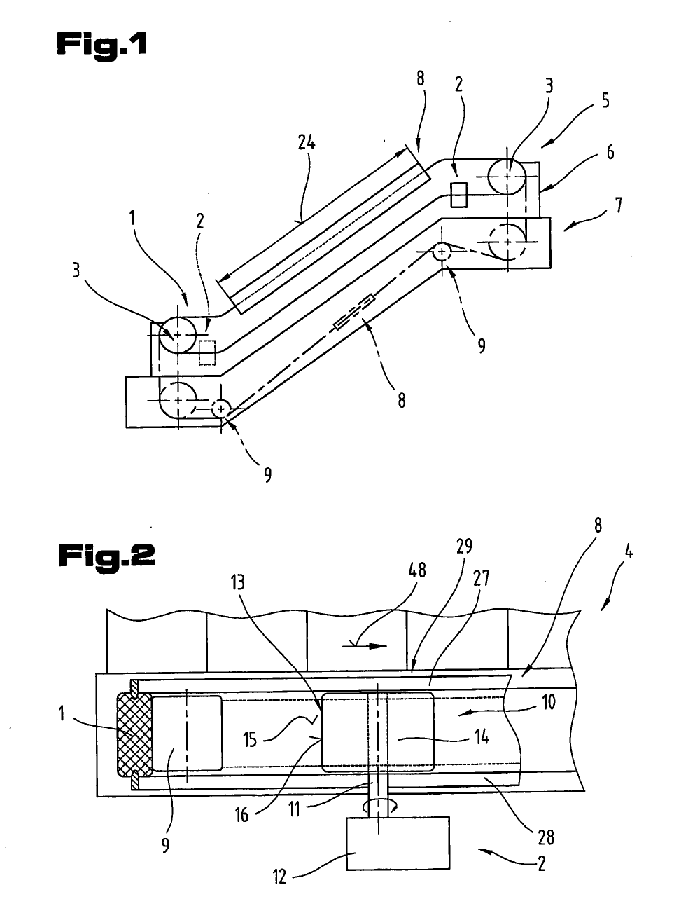

FIG. 1 is a side view of an escalator or moving sidewalk with a handrail and handrail driving system as defined by the invention.

FIG. 2 is a top view of a part section of an escalator or moving sidewalk with the handrail and handrail driving system as defined by the invention according to FIG. 1.

FIG. 3 is a cross-section of a design variation of the handrail as defined by the invention, with a handrail driving system.

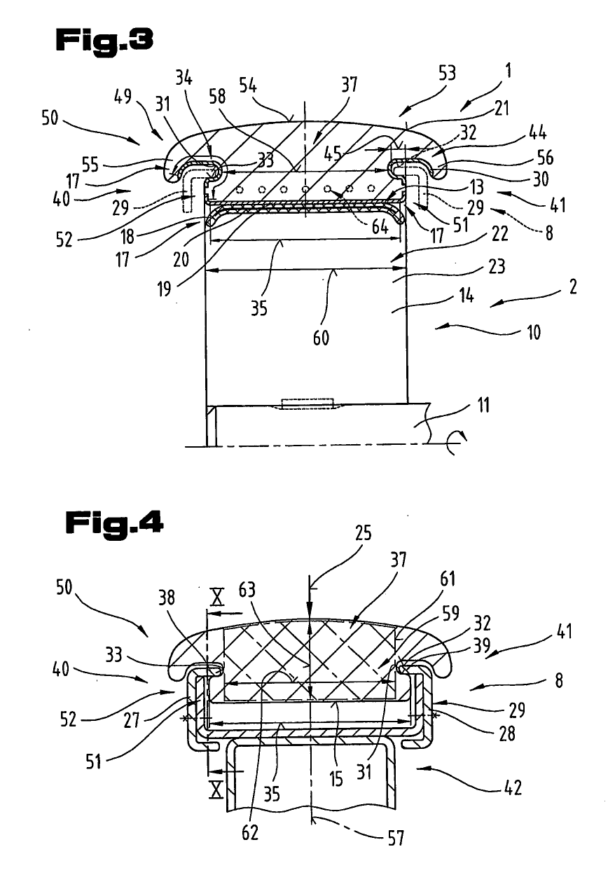

FIG. 4 is a cross-sectional representation of the handrail according to FIG. 3, with a possible design variation of a system for guiding the handrail.

FIG. 5 is a cross-sectional view of another design variation of a handrail with a handrail driving and guiding system.

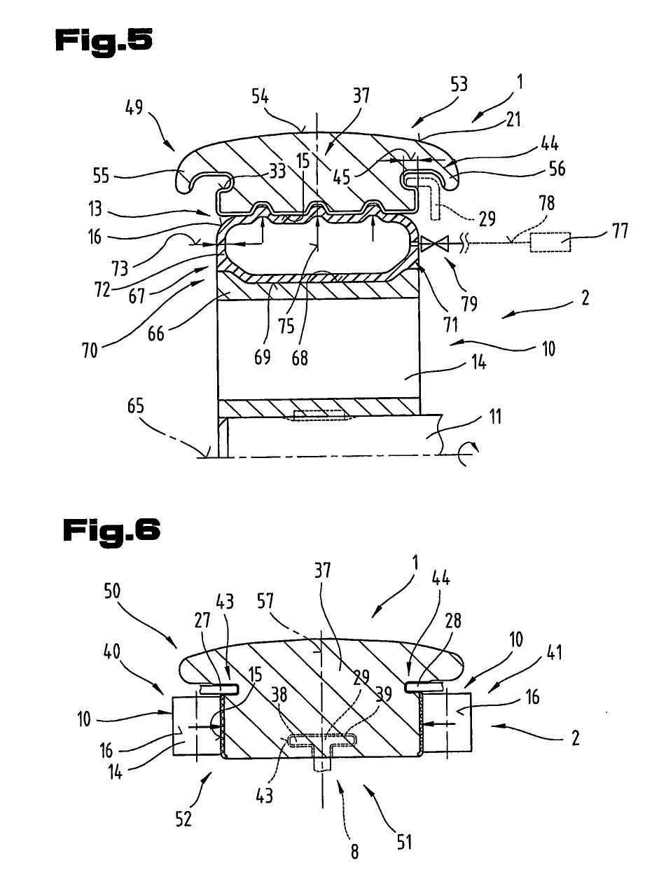

FIG. 6 is a cross-sectional view of still another design variation of a handrail with a handrail driving and guiding system.

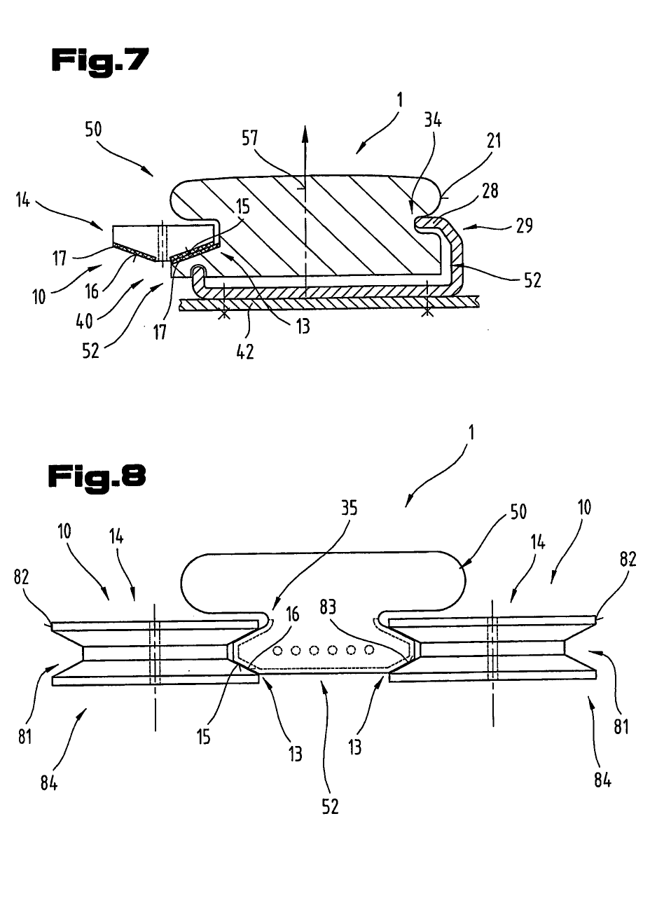

FIG. 7 is a cross-sectional view of yet another design variation of a handrail with a handrail driving and guiding system.

FIG. 8 is a cross-sectional view of another design variation of a handrail with a handrail driving system.

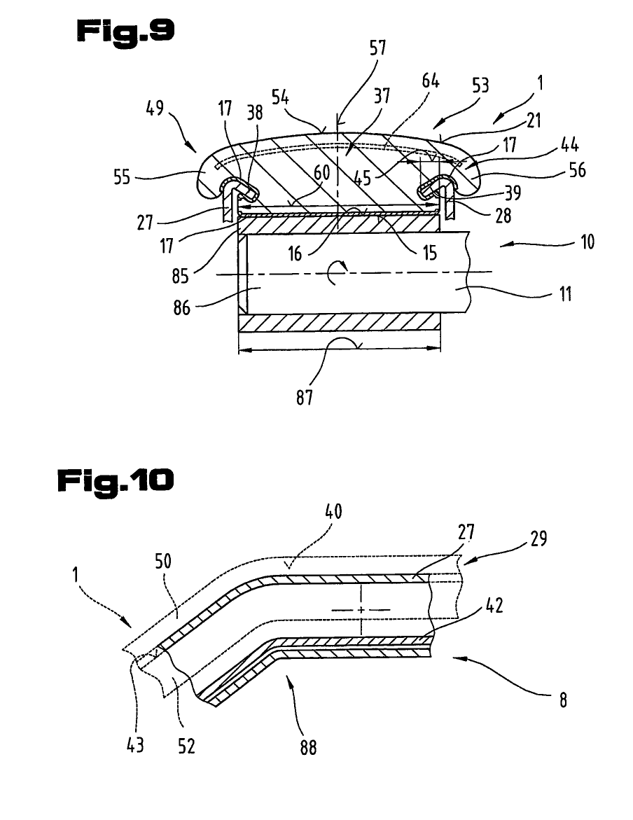

FIG. 9 is a cross-sectional view of yet another design variation of a handrail with a handrail driving system.

FIG. 10 is a sectional view of a part section of a possible design variation of a handrail guiding system in a reversing area cut according to section X-X in FIG. 4.

FIG. 11 is a cross-sectional representation of an independent embodiment of a handrail.

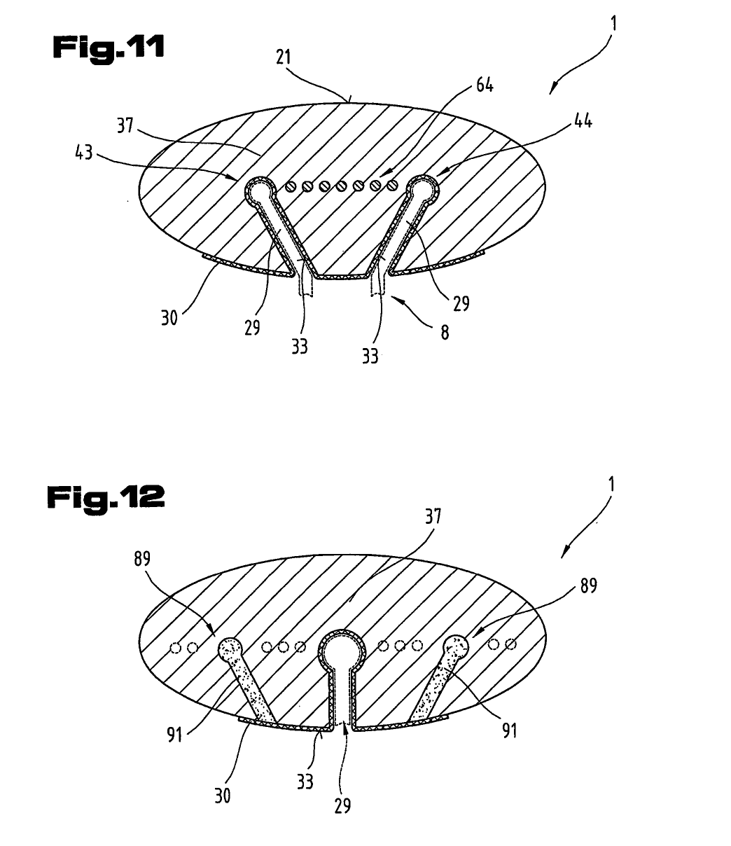

FIG. 12 is a cross-sectional view of another design variation of the independent handrail.

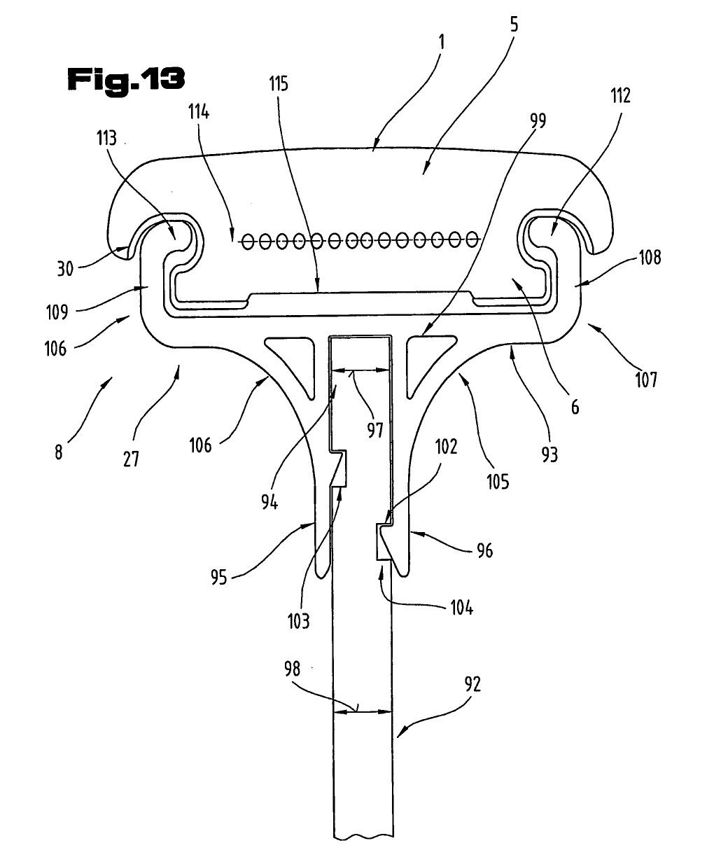

FIG. 13 shows a design variation of a handrail guiding system; and

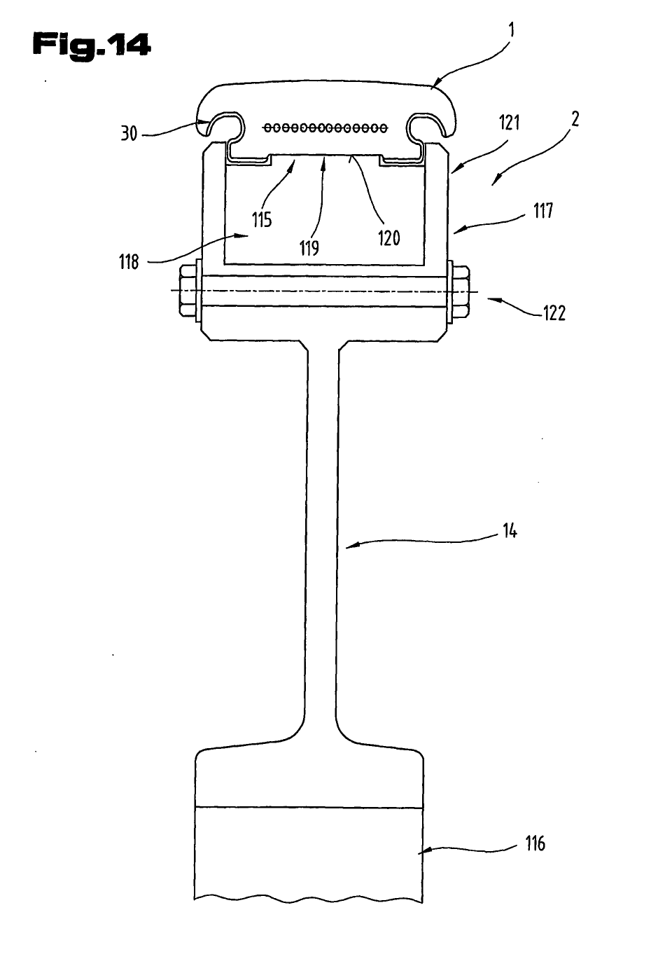

FIG. 14 shows a design variation of a handrail drive.

It is note hereby by way of introduction that in the different embodiments described herein, identical components are denoted by identical reference numbers or identical component designations, whereby the disclosures contained throughout the present specification can be applied in the same sense to identical components denoted by the same reference number or the same component designations. Furthermore, data of position selected in the specification such as, e.g. “top”, “bottom”, “lateral” etc., relate to the figures directly described and shown, and have to be applied in the same sense to any new position where as position has changed. Moreover, individual features or combinations of features of the different exemplified embodiments shown and described herein may per se represent independent solutions or solutions as defined by the invention.

FIG. 1 shows an embodiment variation of a handrail 1 as defined by the invention, which is driven by a handrail driving system 2 and supported by the reversing rollers 3.

An escalator 4 is shown in FIGS. 1 and 2 by way of example for illustrating the handrail 1 and the handrail driving system 2. At least in each of its end areas, said escalator has at least one or more reversing rollers 3, around which the handrail 1 is revolving preferably in the form of an endless belt. A part of the handrail 1 that can be gripped by a person using the elevator, is formed at least over a part area of the upper strand 5, whereby said grippable area represents the part of the handrail extending on the top side of a balustrade of the escalator 4 between the reversing rollers 3. The lower strand 6 is extending between the reversing rollers 3 in the area disposed beneath the upper strand 5, where the handrail 1 is running idle, i.e. it cannot be gripped by an individual in said area between the reversing rollers 3, particularly a person using the escalator. The lower strand 6 is arranged inaccessibly covered in a substructure 7 schematically indicated by dash-dotted lines, or within the balustrade of the escalator for persons.

Since differences in level of altitude have to be overcome by escalators, the latter comprise in most cases also an inclined, ascending area in addition to their horizontal course, so that additional rollers or reversing guides need to be arranged in the transitional areas between different handrail gradients. For this purpose, a handrail guiding system 8 may be arranged for linearly guiding the handrail 1 at least by sections at least in the area of the upper strand 5, as schematically indicated in FIGS. 1 and 2. The reversing rollers 9, which serve for providing the handrail 1 with its direction for fixing its ascending course and, furthermore, if necessary, for adjusting the tractive force in the handrail 1 in order to compensate for any loss of tension caused by material fatigue phenomena after the handrail 1 has been operated for a long time, as well as for preventing the latter from sagging, are schematically indicated in FIG. 1.

It is noted herewith that the object according to the invention is not limited to its application to the escalator 4 schematically shown in FIG. 1, but that the handrail 1 and the handrail driving system 2 are applicable as well to other suitable transportation systems such as, for example people-movers, circularly moving sidewalks etc, for overcoming a difference in altitude, or with a plane course, whereby such systems may be systems for transporting people or freight.

FIG. 2 shows a schematic top view of a part area of the escalator 4 according to FIG. 1 by a broken representation, its purpose being to illustrate the interaction between the various components of the handrail 1, the handrail driving system 2 and the handrail guiding system 8.

The handrail driving system 1 has at least one driving element 10, which is actively connected with a driving motor 12 via a driving means 11, particularly a driving shaft. All systems for generating motion, particularly for generating rotational motion known in the prior art can be employed and serve as the driving motor 12, whereby preferably controllable electric motors or stepped drives are used. The driving element 11 coupled with the driving motor 12 is designed as a motion-transmitting element for driving the driving element 10, which is actively connected with the driving means 11 as well.

Now, the driving element 11 actively connected with the driving motor 12 is designed in such a way that it is in contact with the handrail 1 at least by sections. Due to the direct contact of the driving element with the handrail 1 at least over a contact area 13, motion can be transmitted in the presence of adequate contact pressure exerted between the contact surfaces abutting one another, from the driving element 10 to the handrail 1 by means of static friction. For said purpose, the driving element 10 shown in the exemplified embodiment is formed by a rotatable driving wheel 14, by which the rotational motion transmitted through its active connection with the driving motor 12 to the driving wheel 14, is converted through interaction with the handrail 1 into a translatory movement of the handrail 1 in the contact area 13. In this conjunction, the handrail 1 has, for example a planar contact surface 15 disposed on the bottom side of the handrail 1, said contact surface extending over the entire longitudinal expanse of the handrail 1 and being in contact in the contact area 13 with the driving wheel 14 by friction grip.

It is noted herewith that for realizing a simple structure of the handrail drive 2, the driving wheel 14 is used to serve as the driving element 10 for directly transmitting motion to the handrail 1. However, also other systems such as, for example driving belts can be employed as driving elements 10 for forming a contact area 13 with a large surface area, as described in greater detail below in connection with FIG. 9.

Now, according to the invention, provision is made that the material pairing formed in the contact area 13 of the handrail 1 and the driving element 10 has, in the installed condition, adequately safe static friction between such pairing under all occurring stress conditions. For said purpose, said pairing has a static coefficient of friction of greater than or equal to 0.95, which ensures that the handrail 1 can be safely driven by the driving element 10, for example on the escalator 4, and that any occurrence of sliding friction between the pair of materials can be substantially prevented.

The handrail driving system 2, in conjunction with the handrail 1 as defined by the invention, thus forms a system permitting the handrail 1 to be driven by friction grip, so that no positive transmission elements such as, for example toothed belts or gears etc. have to be employed. In order to assure adequate operational safety of the handrail 1, i.e. to particularly prevent the latter from slipping through as force is being admitted to it, i.e. to prevent any sliding friction from occurring between the driving element 10 and the handrail 1 in the contact area 13, a friction coefficient “μ”, particularly a static coefficient of friction “μ” in the range of about 1 is required. The static coefficient of friction “μ” may be in the range of, e.g. 0.95 and 1.5, particularly of from 1 to 1.2, whereby it has not been known in the prior art heretofore to use for a combination comprising a handrail 1 and a handrail driving system 2 surface pairings with friction coefficients in excess of 0.9. The static coefficient of friction “μ” is dependent upon various influence factors such as surface condition, contamination, liquid or greasy films caused, for example by the formation of condensed water. Such influences, however, can be minimized or almost neglected by a structure of the system that is accordingly adequately protected from external influences. However, the significant factor influencing the friction coefficient or static coefficient of friction is the material used for the handrail 1 and the driving element 10 in the contact area 13, and the contact pressure exerted between the contact surfaces 15 and 16 in relation to one another, as it is familiar to any expert in this field according to the relation μ=F_{R}/F_{N}.

So as to make sure that the interacting material pairing has a static coefficient of friction of ≧0.95, it is necessary to form the combination of the materials, i.e. of the driving element 10 and the handrail 1 in the contact area 13 in such a way that the required friction is safely obtained with a little contact pressure exerted between the contact surfaces as possible for minimizing the material wear. For said purpose, the driving element 10 of the handrail driving system 2 can be formed on the contact surface 15 that is interacting with the contact surface 16 of the handrail in the contact area 13, by a material selected from the group of thermoplastic elastomers or rubber. At least the surface area on the contact surface 15 of the driving element 10 is usefully formed by a rubber or gummed fabric, because such elastomers exhibit poor sliding, but good adhesion properties when interacting with other surfaces. However, non-plastic materials exhibiting such properties can be used as well.

By using rubber-like materials or elastomers, it is advantageous that as opposed to a contact area 13 formed in lines when rigid materials are used and contact pressure is exerted on the surfaces 15 and 16 contacting one another, the deformation of the elastic material forms in the contact area 13 a flat or laminar zone of contact between the surfaces 15 and 16 being in contact with each other, and the surface pressure required between the contact surfaces 15 and 16 for generating the required static friction is automatically generated due to the resetting force of the deformed elastic material.

Now, it is shown in FIG. 3 that the material can be applied to the handrail 1 and/or the driving element 10 in the contact area 13, which means the basic bodies of the handrail 1 and driving element 10 can be formed by normally employed materials such as, e.g. plastics and metals, whereas the friction layers 18 and 19 raising the static friction are formed in the contact area 13 due to the interaction between said layers. The friction layers 18 and 19 or sliding layers (described hereinafter), however, they may also form independent layers or coatings, which are secured on the handrail 1, the guiding element 29 or the driving element 10 at least in the contact areas 13 and 34, whereby such sliding or friction-imparting layers may incorporate the reinforcing layers 20, if necessary.

Thus the driving wheel 14 may be formed by a metallic basic body or from a hard plastic, particularly a thermosetting plastic with good surface sliding properties at least in the contact area 13, but provided, however, with a friction layer 17 formed on the contact surface 15. Such driving wheels 14 are produced, e.g. in the form of gummed-metal driving wheels comprising a friction-imparting layer formed by a rubber or a gummed fabric.

It is possible also that the handrail 1 comprises on its contact surface 16 a friction coating 18 applied to said contact surface, such a friction layer having basically the properties of the friction layer 17 described above, i.e. said friction coating may be applied to the handrail 1 as a type of special coating increasing the friction coefficient.

It is noted herewith that it is possible also to apply only one of the materials in the area of the contact surfaces 15 and 16 in the form of a coating 17, whereas the other material of the contact surfaces 15 and 16 is formed uniformly with the basic material of the handrail 1 and the driving element 10, respectively. All kinds of material pairings are possible for obtaining static friction between the contact surfaces 15 and 16. All of such pairings are known to the expert engaged in the field of material technology and can be used in conjunction with the present invention, and also any exchange between or variation of the materials falls within the scope of skills of the expert.

Furthermore, the coating may comprise one or more reinforcing layers 20, whereby, e.g. woven and knitted fabric reinforcements, thin-walled stiffening profiles made of metal and/or plastic etc., are used as such reinforcing layers serving for enhancing one or more metal properties. Most of all, a coating 17 formed with an incorporated reinforcing layer 20 in conjunction with the handrail 1, may increase the strength properties of the latter, particularly the tensile strength, or enhance material-specific properties of the handrail surface 21 such as, e.g. its resistance to wear and scratching, etc.

The yarns of the pieces of fabric may be made both from synthetic fibers such as, e.g. polyamide or polyester, and/or natural fibers such as, e.g. cotton, sisal, or hemp.

The handrail 1 is usefully flexible and deformable at least in its longitudinal direction. In particular, its bending stiffness has to be sufficiently low in the longitudinal expanse for permitting the handrail to form within the area of the reversing rollers 9 a rounding radius conforming to said rollers for running around the latter. The handrail 1 should substantially have such low inherent stiffness that when it is in the horizontal position, its own weight prevents it from automatically maintaining itself in said position without, and it will start to curve downwards already at only a minor standard distance from the clamping point.

In connection with a further design variation of the handrail driving system 2 not shown, it is possible to provide the driving element 10 with an outer shell that is formed as a separate component connected with the driving element 10 or secured on the latter, so that the contact surface 16 of the driving element 10 is formed on an external surface of the outer shell. For example, the driving wheel 14 thus can be provided on its external radial, revolving surface with a one-component or multi-component external shell preferably realized in the form of a type of bearing socket or bearing sleeve surrounding the revolving surface of the driving wheel 14. By arranging an external shell on the driving element 10 or driving wheel 14, such a shell being formed by a material required for obtaining adequate static friction, it is not necessary for the basic body 22 formed as a wheel hub 23 for a driving element 10 in the form of the driving wheel 14, to undergo a coating or surface treatment process, whereby the separate external shell is secured on the basic body 22, for example mechanically via a groove-and-spring connection means.

A static coefficient of friction of higher than or equal to 0.95 can be obtained also through increased surface roughness on the contact surfaces 15, 16 in the contact area 13, in addition to obtaining it through selection of a suitable material. It is, therefore, possible also that the paired materials of the contact surface 15 and 16 each have a minimum depth of roughness accordingly and form in cooperation an adhesive connection on the contact area 13 by interacting with each other. It is advantageous in this conjunction that hard materials with rigid dimensional properties of their form, i.e. non-elastic materials may form a connection by friction grip, because such materials engage one another even at low contact pressure, so that the motion of the driving element 10 can be transmitted to the handrail 1 via the contact surfaces 15 and 16.

FIGS. 1 to 4 show that the handrail 1, in addition to cooperating with the handrail driving system 2, interacts with the handrail guiding system 8 as well.

The handrail guiding system 8 preferably extends at least over a longitudinal section 24 on the upper strand 5, so that the handrail 1 can be used as a support element at least in the area where persons are transported. This permits force to be admitted—according to arrow 25—to the top side 26 of the handrail 1 without diverting the latter from the course along which it is guided.

It is possible for the handrail guiding system 8 to extend along the entire upper and lower strands, and thus in an endless loop conforming to the course of the handrail 1. It is possible in this way to prevent excessive sagging due to continuous guidance, and thus deformation of the handrail 1, which may lead to, for example material fatigue phenomena, or cause the handrail to slip through on the driving element 10 as the handrail 1 is being stressed by its load. As indicated in FIG. 1 by dash-dotted lines, it is useful in most cases to form the handrail guiding system 8 in the area of the upper strand 5 substantially over the entire longitudinal expanse of said strand, and to form the handrail guiding system 8 only over a part area of the lower strand 6 for supporting the handrail there. In the exemplified embodiment shown in FIGS. 2 to 4, the handrail guiding system 8 is provided, for example in the form of the guiding elements 29 realized in the form of the guiding rails 27 and 28, the latter each being in contact with the handrail surface 21 particularly in a surface area 31 formed on a sliding layer 30. As already described above, said sliding layer 30 may be applied to the handrail 1 in the form of a coating, or may be secured as a separate layer on the handrail 1 by means of a known connection method, whereby the sliding surface 33 may be formed, for example by a woven or knitted fabric as mentioned above.

The handrail guiding system 8 is adapted for interacting with the handrail 1 as a sliding guidance system, i.e. the surface areas 31 of the handrail 1 and the surface areas 32 of the guiding elements 29 contacting one another are in direct contact with each other, and are displaceable in relation to each other with the least possible resistance to friction.

The surface area 31 on the handrail, which is engaged with the surface area 32 of the guiding element 29, is therefore realized in the form of a sliding surface 33, whereby the latter is forming a material pairing in cooperation with the guiding element 29 in a further contact area 34, said material pairing having the lowest possible coefficient of sliding friction amounting to less than or equal to 0.3, e.g. in the range of from 0.15 to 0.25.

Therefore, the handrail 1 is divided on its handrail surface 21 preferably in a first section 35, in which the contact surface 15 for cooperating by friction grip with the contact surface 16 of the driving element 10 is extending, and a further section 36, with the sliding surface 33 being formed in said further section 36 of the handrail surface 21, said sliding surface interacting with the surface area 32 of the guiding element 29 in a gliding or slipping manner, i.e. with very low resistance to friction.

For said purpose, the sliding surface 33 in the further section and/or the surface area 32 of the guiding element 29 may be formed by a material that is formed through application of a material layer by means of a coating 17, which may comprise a reinforcing layer, if need be, for example of the type as already described above for the contact area 13. Another material can be used in this connection that may be different from the one used in the first contact area 13, if necessary.

With a handrail 1 having different properties of friction in the section 35 and further section 36, the coatings or surface-treated sections, or separately applied layers required for friction grip, or a sliding connection need to be formed only over a small part area of the handrail surface 21, thus permitting a reduction of costs and expenditure for the manufacture of the handrail 1.

It is generally noted herewith that for attaining the required friction coefficients in the first and the further contact areas 13 and 34, respectively, the two contact surfaces of the material pairings can be treated in each of said areas by applying material coatings, or carrying out surface treatment processes. However, it is possible also to prepare only one of the interacting contact surfaces in such a manner that such one contact surface has the desired friction coefficient when interacting with the other contact surface. For example, it is possible to form at least the surface area 32 of the guiding element 29 by a material which, in cooperating with the sliding surface 33, exhibits the desired properties for sliding smoothly without any additional coatings or sliding layers, by carrying out, if need be, only a surface treatment process such as, e.g. edge layer hardening in connection with metals, or vulcanization in connection with cross-linked elastomers. For example, the guiding element 29 may be realized in the form of a guiding rail 27, 28 made of metal or stainless steel, whereby it is of course possible also to provide at least one of the interacting zones in the further contact area 34 with a material or sliding layer, e.g. with a woven or knitted fabric consisting of textile, plastic fiber or ceramic materials, or mixtures thereof, or with a material selected from the group of polymers, particularly a wear-resistant plastic.

According to another realizable embodiment of the handrail 1 and the handrail driving system 2, the contact surface 15 is formed from the material employed for the basic body 37 of the handrail, whereby the surface of said contact surface may be treated, if necessary, and whereby the contact surface 15 interacts with the contact surface 16 of the driving element 10, and whereby the contact surface 16 of the driving element 10 has a material or surface structure suitable for producing a material pairing by friction grip, e.g. an increased depth of the roughness of said surface.

In the feasible variation shown in FIG. 4 for embodying a handrail guiding system 8, the latter comprises the guiding rails 27 and 28, which, with the extensions 38 and 39, respectively, in the lateral areas 40 and 41, respectively, engage profile legs in the lateral areas 40 and 41, respectively, of the handrail 1 opposing each other, for the purpose of contacting sections of the sliding surfaces 33 formed in said side areas. As shown, the guide rail 27, 28 is formed, for example in the shape of a U-profile, and connected with and secured on a guiding frame 42, whereby the latter in turn may be formed by one or more profiles, particularly U-profiles. It is noted in general that the design variation of the guiding system 8 shown in FIG. 4 represents only one of many possible variations that can be used in combination with the object of the present invention, and that sliding guiding systems known in the prior art can be employed in conjunction with the handrail 1.

FIGS. 3 and 4 show, furthermore, that in the exemplified embodiment shown there, the basic body 37 of the handrail has at least one recess 43, 44 in each of its lateral areas 40 and 41, respectively, so that a weakening of the cross-section of the handrail 1 having the depth 45 is formed with respect to the width of the handrail. The handrail 1 may have, for example a substantially rectangular or ellipsoidal cross-section of the profile, preferably provided with one or several recesses 43, 44.

The recesses 43 and 44 preferably have the shape of grooves disposed in the lateral areas 40 and 41, respectively, such grooves and their limiting surfaces jointly forming the sliding surfaces 33. The contour of the sliding surfaces 33 of the recesses 43 and 44 is preferably shaped in such a way that the extensions 38 and 39 for holding the handrail 1 are capable of positively engaging the recesses 43 and 44, respectively, and that owing to the extensions 38 and 39, longitudinal guidance according to arrow 48 (FIG. 2) through the surface area 32 formed on said extensions can take place at the same time for continuously moving the handrail, whereby a U- or V-shaped peripheral contour of the sliding surfaces 33 limiting the recesses 43 and 44 was found to be useful.

Now, as shown in the present exemplified embodiment, the extensions 38 and 39 substantially engage the recesses 43 and 44, respectively, in the lateral areas 40 and 41, respectively, like pairs of pliers, so that the handrail 1 is denied any degree of freedom except for the direction of movement according to arrow 48, as well as in the opposite direction. Owing to the positive connection between the handrail 1 and the handrail guiding system 8, it is possible to provide a handrail 1 that is secured against any unintentional detachment from the handrail guiding system 8, which means that intentional damage by tearing the handrail 1 or lifting it off from the handrail guiding system 8 can be prevented, and the components interacting with said system are secured against damage caused by vandalism.

Due to its active connection with the handrail driving system 2 and the handrail guiding system 8 described above, and in conjunction with its simple and compact structure, as well as by virtue of the interaction between the surfaces in the different sections 35 and 36 of the handrail, with its components resting against said sections, particularly the driving element 10 and the guiding element 29, the handrail 1 can be advantageously operated in a reliable manner. It is, furthermore, advantageous in this connection that the handrail guiding system 8 does not have to comprise any moving components such as, e.g. guiding rollers, so that components susceptible to failure such as bearings for revolving rollers can be avoided, and maintenance intervals can be prolonged.

In the possible embodiment variation of the handrail 1 shown, the latter is formed in the upper area 49 by a top belt 50, and in the lower area 51 by the bottom belt 52.

The top belt 50 mainly serves as the gripping piece 53, which is freely accessible to individuals, particularly people, and can be gripped by people on the gripping surface 54 formed at the top side of the handrail 1. It is noted that the term “individuals” may relate to objects as well that may be in contact with the gripping surface 54, thus permitting a secured transport of such objects in cooperation with the handrail 1.

In each of the lateral areas 40 and 41 of the handrail 1, the top belt 50 has a covering extension 55 and 56, respectively, which, in the installed condition, extend like side wings at the top side 26 of the handrail guiding system 8 for covering the guiding elements 29 extending over the latter, so that the handrail guiding system 8 and the handrail driving system 2 are hidden at the top side 26 of the handrail 1 by the latter.

The bottom belt 52 of the handrail 1 is designed to represent the active element formed in the contact areas 13, 34 for driving the handrail 1 by friction grip in cooperation with the driving element 10 and the guiding elements 29 in the first section 35, and, furthermore, for forming in the further section 36 the positive, yet sliding connection between the handrail 1 and the guiding element 29 for guiding the gliding motion of the handrail. Thus the bottom belt 52 is actively joined with the driving element 10 and, in addition, preferably actively connected with the handrail guiding system 8, whereby such active connection is substantially produced by different friction coefficients in the first and further sections 35 and 36, respectively, suitable for their respective functions.

The top belt 50 and the bottom belt 52 of the handrail 1 are preferably realized in the form of one single, one-piece component, particularly by the basic body 37 of the handrail, said body consisting of a uniform material, whereby according to the design variations shown, a cross-sectional weakening is formed on the handrail 1 by the recesses 43 and 44 arranged in the transitional zone between the top and bottom belts 52 and 53, respectively. Now, a connecting bridge 59, via which the top and bottom belts 50 and 52, respectively, are connected, is extending between the respective bottoms of the grooves or recesses 43 and 44 over a width 58. The width of the connecting bridge 59 should amount to about 50% to 95% of the width of the bottom belt, so that the notching impairing the strength properties can be kept as small as possible by the recesses 43 and 44 in the lateral areas 40 and 41, respectively, whereby it was found to be useful if the width 58 of the connecting bridge 59 is in the range of from 75% to 85% of the width of the bottom belt, because a cross-section of the handrail 1 in the form of a full profile extending over the width 58, in conjunction with an adequately positive connection owing to a sufficiently dimensioned depth 45 between the guiding element 29 and the handrail 1, is available for holding the latter.

The supporting profile cross-section 61, which is important for the tensile strength and resistance to pressure of the handrail 1, is shown by dash-dotted lines. Said cross-section has a substantially rectangular or ellipsoidal shape, whereby the ratio between the length 62 of the profile cross-section and the height 63 of the latter may be, e.g. in the range of 1:1 and 5:1, particularly 1.5:1 and 2.5:1. The supporting profile cross-section 63 substantially corresponds with the cross-sectional surface area of the connecting bridge 59, whereby the measurements of the latter have to be dimensioned in such a way that under the force acting on the top belt 50, in conjunction with the guiding and driving force acting simultaneously on the bottom belt 52, the handrail 1 will deform only slightly or not at all, and no cracks or fissures are formed in the handrail 1 in any case, whereby the cross-section 61 of the profile covers a surface area of from 50% to 95%, particularly from 70% to 85% of the entire cross-sectional area of the handrail.

With such a formation of the cross-section, what can be achieved in this way is that the handrail 1 will exhibit adequate strength properties, particularly tensile strength imparted by its basic body 37, so that the handrail can be formed without any additional reinforcing inlays incorporated in its basic body 37, and the usual handrail materials such as, e.g. rubber or thermoplastic materials can be employed as basic materials for the handrail.

A further independent solution for a handrail 1 or its cross-sectional shape is specified as part of the description of FIGS. 11 and 12.

It is noted herewith that the C- or U-shaped profiles employed in the prior art have to incorporate reinforcing layers in order to assure adequate tensile strength of the handrail, namely because their profile cross-sections have only small surface areas on account of the their very small dimensions of width in relation to the length. With the cross-sectional form according to the handrail 1 as defined by the invention, however, such reinforcements are advantageously not required. However, as already indicated above, it is possible to apply to the handrail the reinforcing layers 20 at some later time in the form of a coating 17 applied in the area of the surface 21 of the handrail, as layers for changing the component properties of the handrail 1. Such a possibility, however, needs not to be taken into account in the manufacture of the basic body 37 of the handrail.

Owing to the novel cross-sectional shape of the handrail 1, the expenditure for its production can be reduced due to simplified preparation or set-up of the manufacturing tools, and cost savings are achievable owing to a more reliable manufacturing process, whereby the basic body 37 of the handrail can be manufactured by production methods such as, for example discontinuous press vulcanization or plastics extrusion methods known in the prior art. Furthermore, owing to the changed cross-section, the rate of production rejects can be substantially reduced, because as opposed to and unlike in the prior art, variations in the cross-section can be reduced or entirely excluded in the manufacturing process on account of the much higher length-to-width ratios, since thin-walled legs or profile cross-sections that are difficult to manufacture, will substantially be excluded in connection with the cross-sectional shape as defined by the invention.

However, for additionally increasing the tensile strength, it is mentioned herewith that it is possible to arrange in the basic body 37 of the handrail the tension carriers 64, e.g. in the area of the bottom belt 52. Such tension carriers can be formed, for example by reinforcing elements or layers thereof, particularly steel cords, steel sheets, plastic reinforcement fibers, glass fibers, etc.

FIG. 5 shows a further embodiment variation of the handrail driving system 2 in conjunction with the handrail 1.

The driving element 10 of the handrail driving system 2 is formed in this connection by a driving wheel 14, which can be put into rotational motion by the driving means 11 coupled to the driving motor 12, revolving around the axis of rotation 65 as indicated by the arrow. In this conjunction, all types of shaft-and-hub connections known in the prior art can be employed as connecting systems between the driving means 11 and the driving wheel 14, including, e.g. a groove-and-fitted spring connection as indicated by broken lines.

Now, the driving wheel 14 is formed by a wheel hub 66 and a friction body 67 mounted on said wheel hub, whereby said friction body 67 can be mounted on a revolving surface 68 of the wheel hub 66 by initial radial tensioning, particularly tensile stressing of an elastic friction body 67, and thus by the force of the pressure acting on the revolving surface 68, and/or by means of a form-locked or positive connection of the revolving surface 68 with a support surface 69 of the friction body 67. With rigid friction bodies 67, the connection between the revolving and supporting surfaces 68 and 69, respectively, may be produced by adhesive or mechanical fastening elements such as, e.g. screws, with the possibility of using connection methods known in the prior art.

The friction body 67 is capable of expanding at least in the area of the contact surface 16, i.e. its volume can be increased, if necessary. Thus the contact pressure exerted between the two contact surfaces 15 and 16 abutting one another in the contact area 13 can be increased or reduced by controlling the volume of the friction body 67. This means that the static coefficient of friction between the contact surfaces 15 and 16 can be influenced directly.

In the exemplified embodiment shown in FIG. 5, the friction body 67 is formed by a hollow body 70, particularly a gas-inflatable hose 71 having an enveloping wall 72. An elastically yielding material, e.g. a cross-linked elastomer such as, e.g. rubber is used as material for the enveloping wall 72, whereby the wall thickness 73 is dimensioned in such a way that when the volume of a receiving chamber 74 of the hollow body 70 is increased, at least the contact surface 16 of the driving wheel 14 is moved and adjusted in the contact area 13 in the direction facing away from the wheel hub 66. With the design variation of the hollow body 70 comprising a flexible enveloping wall 72, i.e. a wall that is movable or adjustable at least in the contact area 13 at least within the area of the contact surface 16, it is consequently possible to vary in the contact area 13 the static coefficient of friction “μ” of the present surface pairing when the contact surfaces 15 and 16 of the handrail 1 and the driving wheel 14, respectively, are in contact with one another. In other words, the pressure in the receiving chamber 74 can be raised or reduced in this way, such pressure acting on a limiting surface of said receiving chamber 74 in the direction indicated by the arrow 75.

Thus the volume is increased by raising the pressure in the receiving chamber 74, which can be accomplished in a simple manner with the help of a pneumatic supply system, via which gas, preferably air is pumped into the receiving chamber 74, and the hollow body 70 is thus expanded at least in the contact area 13. Preferably, a valve 79, particularly a check valve is arranged in a flow duct of the enveloping wall 72 for connecting the receiving chamber 74 with a pressure generator 77 via a pressure line 78.

Furthermore, according to another design variation not shown, the friction body 67 is adjustable at least in the area of the contact surface 16 via an additional adjusting device, e.g. an activator in the form of a piezo element.

According to yet another possible embodiment variation not shown, instead of using a driving wheel 14 formed as shown in FIG. 5 as a type of multi-component, air-filled tire, the driving wheel 14 can be formed as one single piece preferably as a solid-rubber wheel. Concerning the material “rubber” and the materials used for the various components in conjunction with the present invention, it is generally noted that the term “rubber” comprises all suitable rubber mixtures, rubber nettings, etc.

As shown, furthermore, the contact surfaces 15 and 16 adjoining each other in the contact area 13 are profiled and engage each other complementarily, so that a larger contact surface is formed in the contact area 13, and the frictional surface area is increased as well.

FIG. 6 shows another embodiment variation of a handrail 1 as defined by the invention, with a handrail driving system 2 and a handrail guiding system 8.

In said embodiment, the driving elements 10 are arranged in the lateral zones 40 and 41 of the handrail 1, so that the contact surfaces 16 are acting on the contact surfaces 15 laterally arranged on the lower belt 52 of the handrail 1.

With such a handrail driving system 2, continuous conveyance of the handrail 1 can be accomplished by letting the pressure normally acting on the contact surface 15, i.e. perpendicularly to the latter, substantially normally act, i.e. at right angles on the center plane 57 as indicated by the arrow shown in FIG. 6, and by compensating the counteracting pressure forces by means of the driving elements 10 opposing one another. Owing to the fact that no compressive force is acting in the direction parallel to the center plane, no compressive force generated by the handrail driving system 2 has to be absorbed by the handrail guiding system 8 in the area of the driving element 10, so that the handrail guiding system 8 is not necessarily required at least in said area, or at least can be provided with smaller dimensions.

A possible variation of the embodiment of the handrail guiding system 8 is schematically shown in FIG. 6 by broken lines, whereby with the present variation, the guiding element 29 with the extensions 38 and 39 engages in the area of the bottom belt 52 the lower area 51, which has the recesses 43 and 44, respectively, positively corresponding with the guiding element 29. The guiding element 29 is realized in the form of a T-shaped profile in order to prevent the handrail 1 from lifting off from the handrail guiding system 8. Instead of using a T-shaped guiding element or guiding rail, it is possible also to employ, for example one or more L-shaped guiding rails 27, 28, or a further section-shaped guide rail known from the prior art, for engaging and positively interacting with the handrail 1.

The design variation shown in FIG. 7 shows a handrail 1 actively connected with a driving element 10 and a handrail guiding system 8.

The system can be structured in a space-saving manner by arranging the driving element 10 in the lateral area 40, and the handrail guiding system 8 in the lateral area 41 of the handrail 1, the latter area being disposed opposite the former. For preventing any unintentional detachment of the handrail 1 from the handrail guiding system 8 by lifting it from the latter, in it possible in the present design variation to form the contact area 13 with the contact surfaces 15 and 16 in a slanted manner as shown with respect to the center plane 57, for driving the handrail 1 by friction grip, i.e. at an angle of, e.g. 30° relative to said contact area, whereby the contact surface 16 of the driving element 10 limits the contact surface 15 of the handrail 1 in the direction of the top belt, so that a fixation of its position is achieved by means of the positive connection of the driving element 10 with the handrail 1 in the direction of the arrow shown in the center plane 57 and set to the direction in which the handrail 1 is driven.

The structure of the handrail guiding system 8 is thus simplified because the handrail 1 is secured by sections by the driving system 2 against lift-off in the direction indicated by the arrow by means of the positive connection of the driving system with the handrail.

FIG. 8 shows a design variation of the embodiment, in which the driving elements 10 are formed by the driving wheels 14 each having a recess 81 on their peripheral, revolving surfaces 82, so that the contact area 13 for the handrail 1 is formed through the interaction between the limiting surfaces 83 of the recess 82, said limiting surfaces forming the contact surfaces 16, and the contact surfaces 15 of the handrail 1. The recess 81 has the shape of, e.g. a cone, or it is V- or U-shaped, and the area of the handrail 1 intended for contacting the contact surface 16, is formed in the first section 35, matching the recess 81 for positively engaging the latter.

Owing to such driving elements 10 that are positively corresponding with the handrail 1, no positive engagement of the handrail guiding system 8 in the handrail 1 is required for preventing the latter from being lifted or pulled off, so that the handrail guiding system 8 can be structured in a simpler way.

Owing to the pairing of bevel gears opposing one another as shown in FIG. 8, furthermore, the handrail 1 can be reliably and safely driven due to friction grip that can be readily developed or built up between the contact surfaces 15 and 16 in the beveled recesses 81, whereby the static coefficient of friction can be varied by relatively adjusting the spacing between the beveled gears, so that if the friction grip is too low due to material wear, adequate friction grip can be obtained by increasing the contact pressure between the contact surfaces 15 and 16. Such a measure, i.e. raising of the contact pressure between the contact surfaces 15 and 16 for increasing the friction coefficient, naturally can be applied in connection with all other design variation described herein as well.

Furthermore, several of the driving wheels 14 can be combined to form a caterpillar drive, i.e. several driving wheels 14 can be arranged one after the other in order to permit force to be safely transmitted to the handrail 1. For example, it is possible to drive the handrail 1 in the area of the lower strand 6 by one or more caterpillar drives, and the handrail 1 thus is pushed or pulled along the upper strand 5. In the presence of compressive force acting on the upper strand 5, tensile stress prevails between the point of attack of pressure and the next driving element 10, on the one side, and pressure stress in the handrail 1 on the opposite side between the point of attack and the preceding, propelling driving element 10, so that the materials of the handrail 1 must have a long service life without fatigue phenomena occurring even the handrail is subjected to permanent stress under dynamically changing conditions. As mentioned herein above, mainly cross-linked and thermoplastic elastomers, or gummed materials and fiber- or fabric-reinforced rubber bodies can be used for said reason as materials and elements for the basic body of the handrail.

It is possible to use as elastomers polymeric materials, e.g. thermoplastic elastomers such as TPE, e.g. TPE-U, TPE-V, TPE-O, TPE-S, TPE-A, TPE-E, etc., or also rubber, and all kinds of latices etc.

FIG. 9 shows another embodiment variation of the handrail 1 with a handrail driving system 2 and a handrail guiding system 8 interacting with said handrail. In the present embodiment, the driving element 10 interacting on the contact surface 15 in the contact area 13 with the handrail 1 for transmitting force by friction grip, is realized in the form of a revolving belt 85. Said belt 85 revolves in this connection between at least two rollers 86 coupled with the driving motor 12 for moving with the latter, permitting enhanced transmission of motion by friction grip, because as opposed to linear contact, the area of contact is substantially larger in the contact area 13 with rollers in contact with the contact area 15.

It is noted again with respect to FIGS. 1 to 8 described above that not a linear, but a larger flat contact surface area 13 is formed owing to the fact that rubber is preferably used for forming at least one of the contact surfaces 15 or 16, and that such rubber material is yielding as pressure is being applied to it.

Arranging the driving element 10 on the bottom side of the handrail 1 is advantageous in that the driving element 10 having the width 87 substantially extends over the entire width 60 of the lower belt, which creates a wide contact area 13 between the contact surfaces 15 and 16 conforming to the width 87 of the driving element 10, so that static friction can be safely built up in this manner. The contact surface 15 on the bottom side of the lower belt 52 of the handrail 1 extends in this connection over 50% to 100%, particularly across about 75% to 90% of the width of the handrail, particularly of the width 60 of the lower belt 60.

This represents a further advantage versus profile cross-sections of handrails known in the prior art, particularly the C- or U-shaped profiles, because it has not been possible heretofore to form the contact area 13 of the driving elements 10 over the entire width of the handrail.

It is noted with respect to the handrail guiding system 8, furthermore, that the extensions 38, 39 extending into the handrail 1 for forming the sliding guide, may extend at an angle relative to the center plane 57, which makes it additionally more difficult to detach the handrail 1 or prevent it from being removed from the handrail guiding system 8 unintentionally or without authorization. For said purpose, it is possible, furthermore, to form a plurality of the extensions 38, 39 on each guiding element 29, each of said extensions engaging the handrail 1, in order to additionally reinforce the connection between the handrail 1 and the handrail guiding system 8.

FIG. 10 shows a part area of the handrail guiding system 8 that is designed for engaging the handrail in its lateral areas 40 and 41.

The representation according to FIG. 10 illustrates that in the reversing area between areas in which the handrail 1 is guided with different gradients, provision is made for a deformed or curved guiding element 29 instead of using reversing rollers as usually employed in the prior art. Transferring the handrail 1 to an area of the handrail guiding system 8 with a changed course or angle thus can be accomplished without any additional moving elements by providing the extensions 38 and 39 with the desired shape accordingly. The guiding elements 29 thus are realized in the form of the bent or curved guiding rails 27 and 28, which interact with the handrail 1 in the curved area 88 as well.

FIGS. 11 and 12 show an independent embodiment of a handrail 1, whereby the specifics described above are partly or wholly applicable to the present solution as well.

In the present embodiment, the handrail 1 has a substantially ellipsoidal cross-section and is provided with one or more recesses 43, 44 for receiving the guiding elements 29.

The sliding layer 30 is secured on the handrail 1 as a separate layer, whereby the latter can be fastened by means of a known connecting method such as, e.g. gluing. However, the material can be applied also as a coating as described above in connection with FIGS. 1 to 10.

In the embodiment variations shown in FIGS. 11 and 12, the handrail 1 is formed as a hollow profile. The cross-section of the handrail may conform to, e.g. an O-shaped hollow profile, whereby the share or proportion of the cross-sectional surface area has to be adequately dimensioned for the tensile strength properties and geometric stability required for the handrail 1.

As shown in FIG. 12, it is possible, furthermore, to provide the handrail 1 with the further recesses 89, 90, which permits material savings and a reduced weight of the handrail 1 combined with adequate strength.

The recesses 89, 90 can be filled with a filler 91, which preferably has a low mass or density, but at least acts in the handrail 1 as an agent stiffening the geometry. The filler used may be, for example a plastic foam material, particularly polyurethane foam, a granulate-like material, or other flexibly deformable lightweight materials.

It is noted with respect to the application of the handrail 1 and handrail drive 2 that design variations are possible as well where the handrail 1 is driven and reversed in a horizontal plane at least in part areas, i.e. perpendicularly with respect to the center plane 57, thus forming in the reversal area a curvature extending around the center plane 57, e.g. in conjunction with a people-mover or moving sidewalk.

Furthermore, the reversing rollers 9 may additionally form the driving elements 10 of the handrail driving system 2 for driving the handrail by friction grip.

The friction coefficients occurring according to the invention in the contact areas 13 and 34, particularly the static coefficient of friction and the sliding friction coefficient, were determined with the help of a test apparatus with a test body resting on a surface, whereby in the contact area so formed, said surface and the test body were arranged flatly abutting one another at any time throughout the course of the test.

During the test, a normal force FN perpendicularly acting on the surface was admitted to the test body, while the latter was simultaneously moved along the surface parallel to the latter at a rate “v” under the following test conditions:

Normal force F_{N}: 50 N

Measuring distance: 100 mm

Test rate “v”: 180 mm/min

First pass: 10 mm

Following pass: 5 mm

The resulting coefficient of sliding friction developing in the course of the sliding process was determined with the help of the determined reaction force F_{R}, and the static coefficient of friction with the surfaces still adhering to one another in the contact area.

FIG. 13 shows a variation of the embodiment of the handrail guiding system 8 for guiding the handrail 1. Said handrail guiding system 8 comprises only one guiding element in the form of the guiding rail 27, which can be designed for endlessly moving in the longitudinal direction, i.e. in the direction in which the handrail 1 is moving. It is conceivable, however, that said guiding rail 27 is assembled from identical sections that may be connected among one another via suitable connection means such as, for example gluing, welding, screws or rivets, etc.

In the embodiment variation of the guiding rail 27 shown in FIG. 13, it is advantageous that it can be directly plugged over a balustrade 92, e.g. a glass balustrade, i.e. without using any other connecting means such as an adhesive, as shown in FIG. 13. Therefore, the guiding rail 27 can be secured on the balustrade 92 by means of friction grip and/or clamping force fit. For said purpose, the guiding rail 27 has a groove-shaped recess on the bottom side 93 pointing in the direction of the balustrade 92, said recess being laterally limited by the legs 95 and 96. The width 97 of the recess 94 can be dimensioned in this connection in such a way that it is only slightly larger than the width 98 of the balustrade 92, so that the connection is formed by friction grip. It is also conceivable, furthermore, that the inner sides, i.e. the sides of the legs 95 and 96 facing the balustrade 92, and/or the base 99 of the guiding rail 27, from which base the two legs 95 and 96 are protruding, are coated with a polymer having the elasticity of rubber, e.g. with a natural or synthetic rubber, or that said material is arranged between the balustrade 92 and the legs 95 and 96 or the base in order to increase in this manner the friction grip, and to dampen impacts that may be transmitted via the driven handrail 1 to the guiding rail 27 and consequently to the balustrade 92, in order to forestall in this manner any possible damage, e.g. of the glass balustrade.

The two legs 95 and 96 are preferably forming one single piece jointly with the base of the guiding rail 27, so that said guide rail 27 can be manufactured by an extrusion method. However, it is naturally possible also to join said two legs 95 and 96 with the base 99 of the guiding rail 27 with the help of suitable connecting means such as, e.g. gluing, screwing, welding etc.

At least one holding element 100, 101 having, e.g. the shape of a bridge, is arranged or formed on each of the inner sides of the legs 95 and 96, respectively, facing the balustrade 92, said holding elements being cantilevered in the direction of the opposite leg 95 or 96. As shown in FIG. 13, said holding element 100, 101 is preferably designed in such a way that it has a holding surface 102 projecting from the leg 95, 96 at least approximately at a right angle, and is consequently beveled, if necessary after a short section disposed about parallel to the side wall in the direction of the leg 95, 96. Such beveling permits the guiding rail 27 to more easily slide onto the balustrade 92 while the legs 95 and 96 are being spread simultaneously.

Provision is made in the balustrade 92 for the groove-like recesses 103 and 104 corresponding with and receiving said holding elements 100 and 101, respectively, on sides of the balustrade 92 opposing each other, said recesses facing the legs 95 and 96, respectively.

The groove-like recesses 103 and 104, and the holding elements 100 and 101, respectively, are preferably vertically offset, so that the material weakening resulting from the groove-like recesses 103 and 104 in the balustrade 92 can be kept as minor as possible.

In order to obtain higher stiffness and thus higher strength of the guiding rail 27, it is possible to provide the legs 95 and 96 within the area of the base 99 with the rounded cross-sectional expansions 105 and 106, respectively, whereby such a rounded shape is advantageous in that no sharp edges exist that could pose any risk of injury to the user of the handrail 1, and, moreover, in that it permits a more appealing design of the guiding element 27. It is naturally possible also to realize said cross-sectional expansions 104 and 105 with a sharp-cornered shape. The rounded design, however, is advantageous, furthermore, in that spreading of the legs 95 and 96 as the guiding rail 27 is being pushed onto the balustrade 92 requires less exertion of force.

Viewing the end areas 106 and 107 of the base 99 opposing one another in the cross-section, provision is made for the holding legs 108 and 109, respectively. Said holding legs are disposed at least approximately at right angles and opposite the legs 95 and 96, respectively, for engaging the handrail recesses opposing said holding legs in the area disposed laterally of the handrail. Said holding legs 108 and 109 each have an extension 112 and 113, respectively, whereby the end areas of said two extensions 112 and 113 face each other, so that if the handrail is correspondingly designed as shown in FIG. 13, it can be safely held and guided.

As specified before, the handrail 1 is formed by the upper and lower strands 5 and 6, respectively, said strands being connected with each other via a bridge 114, whereby the latter has a smaller cross-sectional dimension than the upper and lower strands 5 and 6, respectively, so that an at least approximately double-T-shaped cross-section of the handrail is formed.

Now, the two extensions 112 and 113 engage the groove-like recesses, which is made possible owing to of the smaller diameter of the bridge 114 as compared to the upper and lower strands 5 and 6, respectively.

At least the area of engagement where the guiding rail 27 engages the handrail 1, is provided with the sliding layer 30 on the surface of the handrail 1 in order to minimize in this way the friction between the guiding rail 27 and the handrail 1. As shown in FIG. 13, however, said sliding layer 30 is not extending through from one side of the handrail to the other, so that an area clear of the sliding layer remains in the center area 115, and the drive is effected via said clear area as described further below.

The upper strand 5 has two lip-shaped protrusions pointing in the direction of the balustrade 92, said protrusions bridging at least a part area of the holding legs 108 and 109, which permits reducing for the user the risk of getting caught between the handrail 1 and the guiding rail 27.

The guiding rail 27 can be produced from a plastic such as, e.g. polyamide or polyoxymethylene, or from plastics with comparable properties. FIG. 14 shows a cross-sectional view of a handrail driving system 2, which is comprised of a driving wheel 14 formed according to the prior art, with a center boring 116 for receiving the driving shaft. A flange 117 is arranged on the driving wheel 14 on the outer circumference.

The flange 117 serves for receiving a driving chuck 118, which is actively connected with the underside 120 of the handrail in an area 119.

Now, said flange 117 is designed in a way such that a side plate 121 or side wing is detachably connected with the driving wheel 14 in the area of the driving chuck 118 of the driving wheel 14 via a fastening means, e.g. a screw. This permits the driving chuck 118 to be easily replaced by laterally removing said side plate 121, e.g. for repair purposes. However, it is possible also to design said flange 117 in the form of a multi-component flange viewed over the circumference of the driving wheel 14, which, in turn, permits the driving chuck 118 to be inserted. Furthermore, if the driving chuck 118 is expandable, for example as a type of V-belt, the flange 17 can be entirely formed jointly with the driving wheel 14 as one single piece.

FIG. 14 shows that viewed over the cross-section, the bottom side 120 of the handrail is divided in three sections comprising two side areas and the center area 115, the latter conforming to the area 119. As stated already above in connection with FIG. 13, the two side areas are provided at least in part sections with the sliding layer 30 in order to permit sliding in the guiding rail 27 (FIG. 13) with the least amount of friction possible. The center area 115, however, is formed without said gliding layer 30, so that a direct active connection is established between the driving chuck 118 and the material of the handrail 1, which in turn means that a pairing can be formed between the two materials of the handrail 1 and the driving chuck 118, such a pairing having a static coefficient of friction of higher than or equal to 0.95. It is advantageous in this connection that the center area 115 is offset inwards into the cross-section of the handrail vis-a-vis the two end or side areas of the hand rail 1, e.g. in the form of a groove extending around the handrail 1 over its entire length; and that the driving chuck 118 has a corresponding bridge-like offset extending over the entire length as well, e.g. in the form of a bridge preferably approximately as wide as the groove in the handrail 1, or only slightly narrower than the latter, and such a height that the gliding layer 30 will be prevented from coming into contact with the driving chuck 118 in the lateral areas of the handrail.

The exemplified embodiments show possible design variation of the handrail 1, the handrail driving system 2 and the handrail guiding system 8, whereby it is noted herewith that the invention is not limited to the design variations of the invention specifically shown herein, but that also various combinations of the individual embodiment variations among one another are possible, and that owing to the instruction for technical execution imparted by the present invention, such variation feasibility falls within the scope of the skills of the expert engaged in the present technical field. Furthermore, all conceivable design variations feasible by combining individual details of the embodiment variations shown and described herein, are jointly covered by the scope of protection.

Finally it is pointed out for the sake of good order that in the interest of superior comprehension of the structure of the handrail 1, the handrail driving system 2 and the handrail guiding system 8, said systems and their components are partly shown untrue to scale and/or enlarged and/or reduced.

The problems underlying the independent inventive solutions can be taken from the description.

Most of all, the individual embodiments shown in FIGS. 1, 2, 3, 4; 5; 6; 7; 8; 9; 10; 11; 12; 13; 14 form the object of independent inventive solutions. The relevant problems and solutions as defined by the invention are disclosed in the detailed description of said figures.

### LIST OF REFERENCE NUMBERS

1 Handrail

2 Handrail driving system

3 Reversing roller

4 Escalator

5 Upper strand

6 Lower strand

7 Substructure

8 Handrail guiding system

9 Reversing roller

10 Driving element

11 Driving means

12 Driving motor

13 Contact area

14 Driving wheel

15 Contact surface

16 Contact surface

17 Coating

18 Friction layer

19 Friction layer

20 Reinforcing layer

21 Handrail surface

22 Basic body

23 Wheel hub

24 Longitudinal section

25 Arrow

26 Top side

27 Guiding rail

28 Guiding rail

29 Guiding element

30 Sliding layer

31 Surface area

32 Surface area

33 Sliding surface

34 Contact area

35 First section

36 Further or other section

37 Basic body of handrail

38 Extension

39 Extension

40 Lateral area

41 Lateral area

42 Guiding frame

43 Recess

44 Recess

45 Depth

46

47

48 Arrow

49 Upper area

50 Upper belt

51 Lower area

52 Lower belt

53 Gripping piece

54 Gripping surface

55 Covering extension

56 Covering extension

57 Center plane

58 Width

59 Connecting bridge

60 Lower Belt width

61 Profile cross-section

62 Profile cross-section length

63 Profile cross-section length

64 Tension carrier

65 Axis of revolution

66 Wheel hub

67 Friction body

68 Revolving surface

69 Supporting surface

70 Hollow body

71 Hose

72 Enveloping wall

73 Wall thickness

74 Receiving chamber

75 Arrow

76 Limiting surface

77 Pressure generator

78 Pressure line

79 Valve

80

81 Recess

82 Revolving surface

83 Limiting surface

84 Bevel gear

85 Belt

86 Roller

87 Width

88 Curved area

89 Recess

90 Recess

91 Filler

92 Balustrade

93 Bottom side

94 Recess

95 Leg

96 Leg

97 Width

98 Width

99 Base

100 Holding element

101 Holding element

102 Holding surface

103 Recess

104 Recess

105 Cross-sectional expansion

106 End area

107 End area

108 Holding leg

109 Holding leg

110 Handrail recess

111 Handrail recess

112 Extension

113 Extension

114 Bridge

115 Center area

116 Bore

117 Flange

118 Driving chuck

119 Area

120 Bottom side of handrail

121 Lateral plate

122 Fastening means

1. A handrail driving system (2) for a handrail (1), e.g. an escalator (4) or a people-mover, with at least one driving element (10) actively connected with a driving motor (12) and formed for contacting the driving element (10) by areas, characterized in that at least within a contact area (13) formed for contacting the handrail (1), the driving element (10) is made from a material forming in said contact area (13) through interaction with the material of the handrail a pairing having a friction coefficient of higher than or equal to 0.95.

2. The handrail driving system according to claim 1, characterized in that the driving element (10) is formed by a driving wheel (14).

3. The handrail driving system according to claim 1, characterized in that the driving wheel (14) is realized in the form of a gummed metal wheel or solid-rubber tire.

4. The handrail driving system according to claim 1, characterized in that the driving wheel (14) is formed by a preferably expandable friction body (67) arranged on a wheel hub (66) particularly in the form of a fillable hollow body (70) such as, e.g. an air-filled tire preferably consisting of rubber.

5. The handrail driving system according to claim 1, characterized in that at least in the contact area (13), a contact surface (16) of the driving element (10) has a fiber-like structure, particularly a microfiber structure.

6. The handrail driving system according to claim 1, characterized in that at least in the contact area (13), the driving element (10) has a one-component or multi-component outer shell formed by said material, particularly a bearing socket or bearing sleeve.

7. The handrail driving system according to claim 1, characterized in that the driving element (10) has a width (87) at least approximately as large as the width of the lower belt (60) of the handrail (1) in the contact area (13).

8. The handrail driving system according to claim 1, characterized in that the material of the driving element (10) is formed, or the air pressure in the air-filled tire rated in the contact area (13) in such a way that the driving element (10) at least approximately rests flatly on the handrail (1).

9. The handrail driving system according to claim 1, characterized in that the driving element (10) is arranged in a lower area (51) of the handrail (1) for forming the contact area (13).

10. The handrail driving system according to claim 1, characterized in that at least one driving wheel (14) is arranged in one of the lateral areas (40, 41) of the handrail (1) for forming the contact area (13).

11. The handrail driving system according to claim 1, characterized in that one or more driving elements (10) are arranged in series, if necessary, in each of the lateral areas (40, 41) of the handrail (1) opposing one another.

12. The handrail driving system according to claim 1, characterized in that several driving wheels (14) are combined to form a caterpillar drive.

13. The handrail driving system according to claim 1, characterized in that the at least one driving element (10) is formed in areas for positively interacting with the handrail (1).

14. The handrail driving system according to claim 1, characterized in that the contact areas (16) formed on the driving wheel (14) limit, e.g. a cone-shaped recess (81) on the outer revolving surface (82) of the driving wheel (14); and that the contact areas (16) on a driving wheel (14) formed as a type of bevel gear extend slanted relative to the axis of revolution (65) of the driving wheel (14).

15. The handrail driving system according to claim 1, characterized in that on its external revolving surface (82), the driving wheel (14) has an elevation with the contact surface (16) formed thereon.

16. A handrail guiding system (8) for a handrail (1), e.g. of an escalator (4) of people-mover, with at least one guiding element (29) formed in areas for contacting a handrail (1), characterized in that at least in the contact area (34) formed for contacting the handrail (1), the guiding element (29) is realized by a material forming in said contact area (13) jointly with the material of the handrail a material pairing having a sliding friction coefficient of lower than or equal to 0.3.

17. The handrail guiding system according to claim 16, characterized in that at least in the contact area, the material of the guiding element (29) is selected from the group of polymers, particularly a plastic resistant to wear.

18. The handrail guiding system according to claim 16, characterized in that at least in the contact area, the guiding element (29) of the handrail (1) is formed by a woven or knitted fabric consisting of, for example textile, synthetic fiber or ceramic materials, or mixtures thereof.

19. The handrail guiding system according to claim 16, characterized in that the area of the guiding element (29) formed for contacting the handrail (1) is formed for positively engaging the handrail (1) particularly in recesses (43, 44) of said handrail (1).

20. The handrail guiding system according to claim 16, characterized in that at least in an area interacting with the handrail (1), the guiding element (29) has a substantially L-shaped cross-section, and/or the guiding element (29) is realized in the form of a U-shaped guiding rail (27, 28).

21. A handrail (1) for an escalator or people-mover, characterized in that at least in a contact area (13) formed for contacting a driving element (10) in the installed position of the handrail, the handrail (1) is formed by a material forming in said contact area (13) a material pairing interacting with the material of the driving element (10), said pairing having a static coefficient of friction of higher than or equal to 0.95, and/or that the handrail (1) is formed by an upper belt (50) and a lower belt (52) connected by a connecting bridge (59), whereby the connecting bridge (59) has a smaller cross-sectional width than the upper belt (50) and the lower belt (52), and whereby the upper belt (50) has covering extensions (55, 56) in its lateral areas (40, 41), said covering extensions being bent at least in areas at least approximately in the direction of the lower belt (52) in order to cover the connecting bridge laterally at least by sections.

22. The handrail according to claim 21, characterized in that a contact surface (15) is formed on the bottom side of the handrail (1) for contacting the driving element (10) in the contact area (13), said contact surface preferably extending perpendicularly to a vertical center plane (57) of the handrail (1).

23. The handrail according to claim 21, characterized in that the contact surface (15) extends over 50% to 100%, particularly about 75% to 90% of the width of the handrail, particularly the width (60) of the lower belt.

24. The handrail according to claim 21, characterized in that in a further contact area (34) formed for contacting a guiding element (29) of a handrail guiding system (8), the handrail (1) has a sliding surface (33), particularly a sliding layer (30).

25. The handrail according to claim 24, characterized in that in cooperation with a guiding element (29), the sliding surface (33) forms a pairing with a low coefficient of sliding friction amounting to between 0.1 and 0.5, particularly to lower than or equal to 0.3, e.g. 0.15 to 0.25.

26. The handrail according to claim 21, characterized in that the handrail surface (21) is formed in the different contact areas (35, 36) for driving and guiding elements (10; 29) consisting of the same material as the handrail; however, said contact areas having different surface roughness conditions, particularly depths of roughness.

27. The handrail according to claim 21, characterized in that the handrail (1) has at least one recess (43, 44), and that the limiting surface of the recess (43, 44) is preferably formed by the sliding surface (33).

28. The handrail according to claim 27, characterized in that the recess (43, 44) is realized in at least one lateral area (40, 41) of the handrail (1) in the form of a groove preferably having a substantially U-shaped or V-shaped peripheral contour.

29. The handrail according to claim 21, characterized in that the handrail (1) is formed by an upper belt (50) and a lower belt (52) joined by a connecting bridge (59).

30. The handrail according to claim 29, characterized in that a gripping surface (54) for people is formed on the upper belt (50) over a part area of the surface (21) of the handrail.

31. The handrail according to claim 29, characterized in that in its lateral areas (40, 41), the upper belt (50) has covering extensions (55, 56) preferably for hiding a handrail guiding system (8) and a handrail driving system (2).

32. The handrail according to claim 29, characterized in that the lower belt (52) of the handrail (1) is actively connected with the handrail driving system (2) and/or the handrail guiding system (8).

33. The handrail according to claim 29, characterized in that at least one basic body (37) of the handrail comprising the upper belt (50), lower belt (52) and the connecting bridge (59) of the handrail (1), is realized in the form of one single piece consisting of a homogeneous material.

34. The handrail according to claim 29, characterized in that the connecting bridge (59) extends between recesses (43, 44) formed in the lateral areas (40, 41) of the handrail (1), said recesses opposing each other.

35. The handrail according to claim 29, characterized in that the width (58) of the connecting bridge (59) amounts to about 50% to 95%, particularly 75% to 85% of the width (60) of the lower belt of the handrail (1).

36. The handrail according to claim 29, characterized in that the height of the connecting bridge (59) amounts to about 5% to 50%, particularly 10% to 20% of the height of the handrail.

37. The handrail according to claim 21, characterized in that reinforcing elements such as, for example tension carriers (64) or reinforcing layers, e.g. of steel wire, steel sheet etc. are arranged in the basic body (37) of the handrail.

38. The handrail according to claim 21, characterized in that the handrail (1) has its supporting profile cross-section (61) at least in the area of the connecting bridge (59), said cross-section of the profile having preferably a substantially rectangular or ellipsoidal shape.

39. The handrail according to claim 38, characterized in that the supporting profile cross-section (61) has a length-to-width ratio in the range of about 1:1 to 5:1, particularly of about 2:1.

40. The handrail according to claim 38, characterized in that the supporting profile cross-section (61) covers a surface area of from 50% to 95%, particularly 70% to 85% of the total cross-sectional surface area of the handrail (1).

41. The handrail according to claim 21, characterized in that the bottom side of the lower belt (52) has a groove-like recess extending over the total length of the handrail, said recess being free of a sliding layer.

42. The handrail driving system and/or handrail according to claim 1, characterized in that at least one of the materials of the material pairing in the contact area (13) is selected from the group of elastomeric materials, particularly cross-linked elastomers, rubber, or thermoplastic elastomers.

43. The handrail driving system and/or handrail guiding system and/or handrail according to claim 1, characterized in that the surface areas adjoining one another are profiled in at least one of the contact areas (13; 34) between the handrail (1) and the driving element (10) and/or between the handrail (1) and the guiding element (29).

44. The handrail guiding system and/or handrail according to claim 16, characterized in that at least one of the surface areas (31, 32) of the handrail (1) and/or guiding element (29) formed for mutually contacting each other, is formed by a further material or sliding layer (30), the latter being different from the material of the handrail (1) in or on the contact area (15).

45. The handrail guiding system and/or handrail according to claim 44, characterized in that the further material or sliding layer (30) is formed by a plastic, particularly a thermoplastic, a metal, or a metal alloy or a ceramic material.

46. The handrail guiding system and/or handrail according to claim 44, characterized in that the further material or sliding layer (30) is formed by a woven or knitted fabric consisting of textile, natural fiber, glass or plastic material, or mixtures thereof.

47. The handrail driving system and/or handrail guiding system and/or handrail according to claim 43, characterized in that in at least one of the contact areas (13; 34) between the handrail and the driving element (10), and/or between the handrail and the guiding element, at least one material of the material pairing is realized in the form of a separate sliding or friction layer, the latter being secured on the handrail (1) and/ or on the driving element (10) and/or on the guiding element (29) particularly by material grip, e.g. adhesive gluing.

48. The handrail driving system and/or handrail guiding system and/or handrail according to claim 43, characterized in that in at least one of the contact areas (13; 34) between the handrail (1) and the driving element (10) and/or between the handrail (1) and the guiding element (29), at least one material of the material pairing formed is applied in the form of a coating (17).

49. The handrail driving system and/or handrail guiding system and/or handrail according to claim 47, characterized in that the coating (17) and/or the sliding or friction layer comprises at least one reinforcing layer (20).

50. The handrail driving system and/or handrail guiding system and/or handrail according to claim 49, characterized in that the reinforcing layer (20) is formed by a woven or knitted fabric.

51. An overall system preferably for application in conjunction with an escalator or people-mover, said overall system at least comprising a handrail (1) actively connected with a handrail driving system (2) and/or a handrail guiding system (8), characterized in that the handrail (1) is formed according of claims 21 to 50, and/or the handrail driving system according to claim 1.
